(19) United States
(12) Patent Application Publication
(10) Pub. No.: US 2024/0199272 A1
(43) Pub. Date: Jun. 20, 2024

(54) PRIMARY BEVERAGE CONTAINER WITH TEMPERATURE CONTROL

(71) Applicant: Novelis Inc., Atlanta, GA (US)

(72) Inventors: Anna E. Janoff, Atlanta, GA (US); John Min Ho, Marietta, GA (US); Cedric Wu, Marietta, GA (US); Hunter Cestoni, Acworth, GA (US)

(73) Assignee: Novelis Inc., Atlanta, GA (US)

(21) Appl. No.: 18/554,193

(22) PCT Filed: Apr. 5, 2022
(86) PCT No.: PCT/US2022/071539

§ 371 Date: Oct. 5, 2023

Related U.S. Application Data
(60) Provisional application No. 63/172,499, filed on Apr. 8, 2021.

(51) Int. Cl. B65D 6/10; A47J 41/00; B21D 51/26; B65D 6/00; B65D 8/00; B65D 17/00; B65D 17/28; B65D 81/38; B67C 3/22

(52) U.S. Cl. CPC B65D 7/22; A47J 41/0072; B21D 51/2646; B65D 7/04; B65D 7/42; B65D 17/02; B65D 17/4014; B65D 81/3869; B67C 3/22; B65D 2517/0031

(57) ABSTRACT

A primary beverage container includes a container body (102) and a container end (230). The container body includes an outer wall (104) and an inner wall (106). The outer wall defines an outer cavity (116), and the inner wall defines an inner cavity (122) with an opening (124) at a top end (108) of the container body. The inner wall is positioned within the outer cavity such that between the top end and a bottom end of the container body, the inner wall is spaced apart from the outer wall within the outer cavity. The container end is joined to the top end of the container body and covers the opening of the inner cavity.

### CROSS REFERENCE TO RELATED APPLICATIONS

This application claims the benefit of and priority to U.S. Provisional Application No. 63/172,499, filed Apr. 8, 2021, which is incorporated herein by reference in its entirety.

### FIELD OF THE INVENTION

This application relates to beverage containers, and more particularly, to thermally insulated aluminum beverage containers.

### BACKGROUND

A container may be configured to store a volume of liquid that may be hot or cold, including but not limited to water, coffee, tea, a soft drink, or an alcoholic beverage. Aluminum and aluminum alloys have been used as primary beverage containers due to their excellent barrier properties, recyclability, and low cost, among other features, but these current primary beverage containers do not allow for temperature control of the liquid. As used herein, a primary beverage container is a container that initially packages the liquid prior to consumer use and/or being sold and has limited reusability, whereas a secondary beverage container is a container that does not initially package a liquid and is reusable. Non-limiting examples of primary beverage containers include soft drink cans and bottles, and non-limiting examples of secondary beverage containers include thermoses and travel mugs.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a primary beverage container includes a container body and a container end. The container body includes an outer wall and an inner wall. In various embodiments, the outer wall includes a first outer surface and a first inner surface, and the outer wall defines a bottom end of the container body. In certain embodiments, the inner wall includes a second outer surface and a second inner surface, and the second inner surface defines an inner cavity comprising an opening at a top end of the container body opposite from the bottom end. The inner wall and the outer wall may be joined at the top end of the container body, and they second outer surface may be spaced apart from the first inner surface between the top end and bottom end of the container body thereby defining an outer cavity. In some embodiments, the outer wall and the inner wall each include an aluminum alloy. The container end may be joined to the top end of the container body and may cover the opening of the inner cavity.

According to some embodiments, a method of forming a primary beverage container includes forming a container body comprising an outer wall and an inner wall and joining a container end with the container body. Forming the container body may include positioning the inner wall between a top end and a bottom end of the container body the inner wall is spaced apart from the outer wall from the top end to the bottom end and defines an outer cavity between the inner wall and the outer wall. Forming the container body may include joining the inner wall and the outer wall at the top end of the container body. Joining the container end with the container body may include covering an opening to an inner cavity defined by the inner wall with the container end.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 is a sectional view of a container body of a primary beverage container according to embodiments.

FIG. 2 is a perspective view of a primary beverage container according to embodiments.

FIG. 3 is a heat map of various containers 30 seconds after being filled with boiled water according to embodiments.

FIG. 4 is a heat map of various containers 30 seconds after being filled with iced water according to embodiments.

FIG. 5 illustrates a portion of a surface of a container body of a primary beverage container according to embodiments.

FIG. 6 is a detailed view of a portion of the surface of the container body of FIG. 5.

FIG. 7 is a graph illustrating heating rates of various metal sheets used to form container bodies of primary beverage containers according to embodiments.

### DETAILED DESCRIPTION

Described herein are primary beverage containers, or the original beverage containers packaged with a liquid, with improved temperature control. The primary beverage container includes a container body and a container end, and in various embodiments, the container body includes an inner wall and an outer wall. In certain embodiments, the double wall of the container body (and optionally a spacer) may provide improved temperature control for a liquid or other material within the primary beverage container and compared to existing primary beverage containers. In some non-limiting examples, the double wall of the container body may allow for a liquid within the primary beverage container to maintain its temperature longer and/or reduce heat transfer and provide a more controlled change in temperature. For example, the double wall primary beverage container may allow a cold liquid to remain cooler for a longer period of time compared to existing primary beverage containers, and conversely may allow a hot liquid to remain hotter for a longer period of time compared to existing primary beverage containers. In some aspects, the double wall primary beverage container may also provide improved safety for a user or handler by minimizing or reducing the change in temperature of the outer wall compared to existing primary beverage containers. In various embodiments, the primary beverage containers described herein may have improved reusability and/or recyclability compared to existing primary beverage containers.

The primary beverage container includes a container body and a container end that together form the primary beverage container, and the container end is coupled with the container body such that an inner cavity of the container body is sealed. Various materials or items, such as food products, beverage products, non-edible products, etc., may be sealed within the inner cavity. An opening mechanism may selectively engage the container and/or otherwise unseal the inner cavity (e.g., by puncturing the container, forming an opening in the container, breaking a score or a seal of the container, etc.). In some embodiments, the container end may include various features such that the container end is selectively removable from the container body to break the seal and/or reclose the container. In other embodiments, the container end may include various sealing features or other features such that the container can be reclosed or resealed as desired. In other embodiments, the container need not be re-closable or re-sealable.

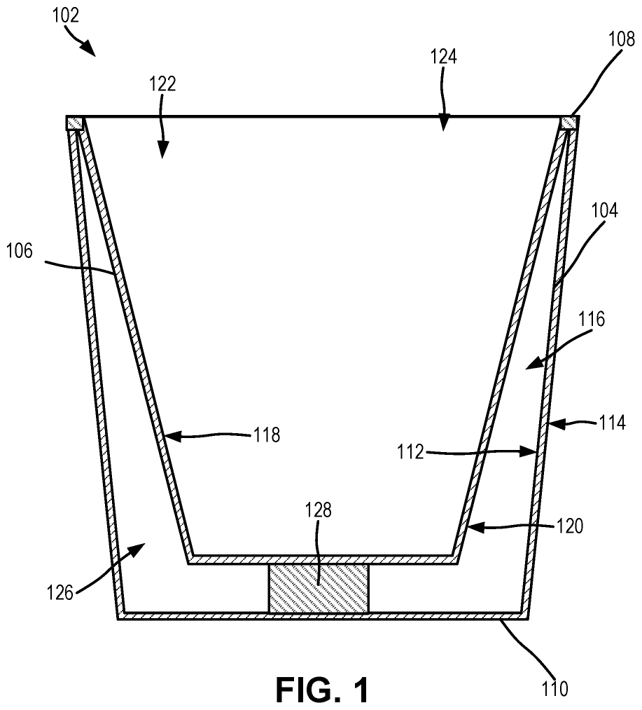

FIG. 1 illustrates an example of a container body 102 of a primary beverage container according to various embodiments. The container body 102 of FIG. 1 is a can body for a can, however in other embodiments the container body 102 (and as such the primary beverage container) may be various other types of primary beverage containers, including but not limited to bottles, cups, etc. Moreover, the particular shape of the container body 102 illustrated in FIG. 1 should not be considered limiting.

As illustrated in FIG. 1, the container body 102 includes an outer wall 104, an inner wall 106, a top end 108, and a bottom end 110. The outer wall 104 includes an inner surface 112 and an outer surface 114. An outer cavity 116 may be defined between the outer wall 104 and the inner wall 106. In certain embodiments, the outer wall 104 forms the bottom end 110 of the container body 102. The inner wall 106 includes an inner surface 118 and an outer surface 120, and the inner surface 118 of the inner wall 106 defines an inner cavity 122 having an opening 124 at the top end 108. In certain embodiments, a volume of the inner cavity 122 is less than a volume of the outer cavity 116. In certain embodiments, and as discussed in detail below, a liquid or other material may be packaged in the inner cavity 122.

In various embodiments, the inner wall 106 and/or the outer wall 104 may be constructed from a metal material. As one non-limiting example, the outer wall 104 and/or the inner wall 106 may be various types of aluminum alloys including, but not limited to, 1xxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, and/or 8xxx series aluminum alloys, and/or various other types of metal materials. In certain embodiments, the material of the outer wall 104 may be different from the material of the inner wall 106. As a non-limiting example, the inner wall 106 may be a 3xxx series aluminum alloy and the outer wall 104 may be a 4xxx series aluminum alloy. Various other types of metal may be utilized as desired. In one non-limiting example, the container body 102 may be constructed from materials such that the primary beverage container is recyclable and/or has an improved ability to be recyclable compared to traditional primary beverage containers. In one non-limiting example, the inner wall 106 and the outer wall 104 may be constructed from a same aluminum alloy; however, they need not be in other embodiments, and other features and/or materials may be utilized such that the container body 102 is recyclable. In some cases, the inner wall 106 and/or the outer wall 104 may optionally be anodized using various anodizing techniques or treatments as desired. In various embodiments, the anodized inner wall 106 and/or outer wall 104 may further reduce heat transfer within the container body 102 and/or may improve thermal insulation. In certain embodiments, and as discussed in detail below, one or more surfaces of the container body 102 may include a surface treatment such as but not limited to laser texturing, which may further improve thermal insulation of the primary beverage container.

As illustrated in FIG. 1, the inner wall 106 is positioned relative to the outer wall 104 such that the a gap 126 is defined between at least a portion of the inner wall 106 and at least a portion of the outer wall 104 while the inner wall 106 is between the top end 108 and the bottom end 110. In certain embodiments, the inner wall 106 and the outer wall 104 are joined at or proximate to the top end 108 via various suitable techniques, including but not limited to seaming, crimping, soldering, welding, blow-forming, or roll-bonding. In other embodiments, the inner wall 106 and the outer wall 104 may be integrally or monolithically formed as a single component. In certain embodiments, the inner wall 106 and the outer wall 104 at the top end 108 may close and/or seal the outer cavity 116.

The gap 126 between the inner wall 106 and the outer wall 104 may provide a thermal barrier between the inner wall 106 and the outer wall 104 that controls the heat transfer between the inner wall 106 and the outer wall 104. The shape and/or size of the gap 126 illustrated in FIG. 1 should not be considered limiting, and gap 126 may have various shapes and/or sizes as desired based on various control factors including, but not limited to, a desired heat transfer or thermal insulation between the outer wall 104 and the inner wall 106, a shape of the outer wall 104, and/or a shape of the inner wall 106.

In certain embodiments, and as illustrated in FIG. 1, a spacer 128 may optionally be provided within the outer cavity 116 between the outer wall 104 and the inner wall 106. In other embodiments, the spacer 128 may be omitted. When included, the spacer 128 may contact at least a portion of the outer surface 120 of the inner wall 106 and at least a portion of the inner surface 112 of the outer wall 104. In certain embodiments, the spacer 128 may maintain a size of the gap 126 in at least a portion of the outer cavity 116. Optionally, the spacer 128 may be constructed from a material having a thermal conductivity that is less than the thermal conductivity of the inner wall 106 and/or the outer wall 104 such that the spacer 128 may provide additional thermal insulation between the outer wall 104 and the inner wall 106. As some non-limiting examples, the spacer 128 may be cardboard, wax, various types or rubber or plastic, combinations thereof, or other materials as desired. The number, shape, type, and/or location of the spacer 128 should not be considered limiting.

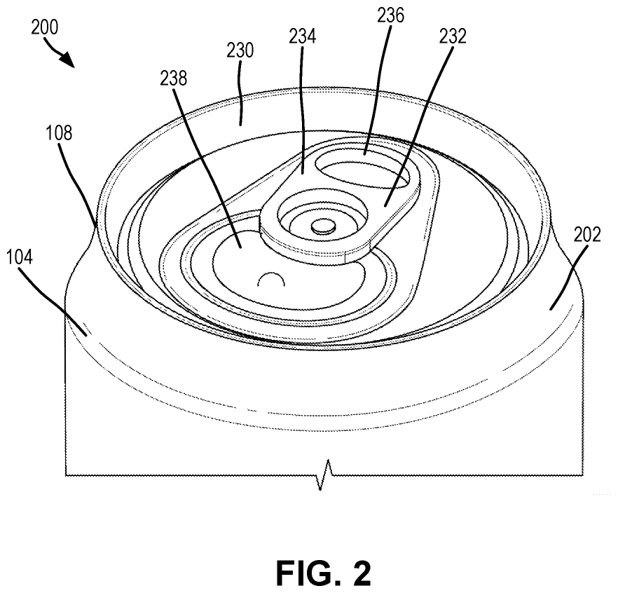

FIG. 2 illustrates an example of a primary beverage container 200 according to various embodiments. The primary beverage container 200 includes a container body 202 and a container end 230. The container body 202 is substantially similar to the container body 102 except that a shape of the container body 202 is different from that of the container body 102, and the top end 108 of the container body 202 is tapered inwards.

The container end 230 may be attached to the top end 108 via various suitable techniques as desired, including but not limited to seaming, crimping, soldering, welding, blow forming, or roll bonding. In other embodiments, the container end 230 may be removably joined to the container body 202 via various suitable techniques such that the container end 230 may be selectively attached to or detached from the container body 202 as desired. As one non-limiting embodiments, the container end 230 may include threading or other suitable features such that the container end 230 can be selectively attached to the container body 202. When the container end 230 is attached to the container body 202, the container end 230 may cover the opening 124 and/or seal the inner cavity 122 of the container body 202.

In certain embodiments, the container end 230 includes an opening feature 232 that may selectively provide access to the inner cavity. In the embodiment of FIG. 1, the opening feature 232 is a pop tab-opening feature 234 having a tab 236 that selectively opens a scored area 238 of the container end 230. In other embodiments, other opening features 232 may be provided as desired. In further embodiments, the opening feature 232 may be a re-sealable and/or re-closable opening feature such that access to the inner cavity 122 may be selectively enabled or prevented as desired.

The container body 202 and the container end 230 may be made of the same material or may be made of different materials as desired. In some embodiments, the container end 230 and the container body 202 may each be constructed from an aluminum alloy. In other embodiments, the container end 230 need not be a metal material.

In certain embodiments, a method of forming the primary beverage container 200 (or other primary beverage containers according to embodiments herein) may include forming the container body 202 and joining the container end 230 with the container body 202. In various embodiments, forming the container body 202 includes forming the outer wall 104 and the inner wall 106 such that an outer cavity 116 is defined between the inner wall 106 and the outer wall 104. At least a portion of the inner wall 106 is spaced apart from the outer wall 104 by the gap 126 between the top end 108 and the bottom end 110. Forming the inner wall 106 and the outer wall 104 with the gap 126 may include various techniques. As one non-limiting example, forming the inner wall 106 and the outer wall 104 may include blow forming the inner wall 106 and the outer wall 104 and joining the inner wall 106 and the outer wall 104. As another non-limiting example, forming the inner wall 106 and the outer wall 104 may include providing a wax layer between two sheets of a metal material (e.g., sheets of aluminum alloys), forming the sheets into the desired shape, and vaporizing the wax between the sheets after forming. As a further non-limiting example, forming the inner wall 106 and the outer wall 104 may include using a double die to form the inner wall 106 and the outer wall 104. As another non-limiting example, forming the inner wall 106 and the outer wall 104 may include roll bonding a sheet of metal to form the inner wall 106 and the outer wall 104. Forming the container body 202 may optionally include joining the inner wall 106 and the outer wall 104 at the top end 108 such that the outer cavity 116 is closed and optionally sealed. In other embodiments, the inner wall 106 and outer wall 104 may be integrally or monolithically formed as a single component. As one non-limiting example, a single metal sheet may be bent or otherwise formed into the container body 202 having the inner wall 106 and the outer wall 104. In some embodiments, forming the container body 202 includes providing the spacer 128 within the outer cavity 116.

Joining the container end 230 with the container body 202 may include positioning the container end 230 relative to the container body 202 such that the container end 230 covers the opening 124, and attaching the container end 230 to the container body 202 such that the opening 124 is closed and/or the inner cavity 122 is sealed. Joining the container end 230 with the container body 202 may include various techniques including but not limited to seaming, crimping, soldering, or welding. Optionally, joining the container end 230 with the container body 202 may include removably attaching the container end 230 with the container body 202 via various mechanisms including but not limited to threading.

Optionally, the process may include filling the inner cavity 122 with a material to be packaged (e.g., a liquid such as coffee, water, tea, a soft drink, etc.) prior to joining the container end 230 with the container body 202. In some non-limiting embodiments, the material filled in the inner cavity 122 is a liquid, although it need not be. In various aspects, joining the container end 230 with the container body 202 may seal the liquid or other material in the inner cavity 122 of the primary beverage container 200.

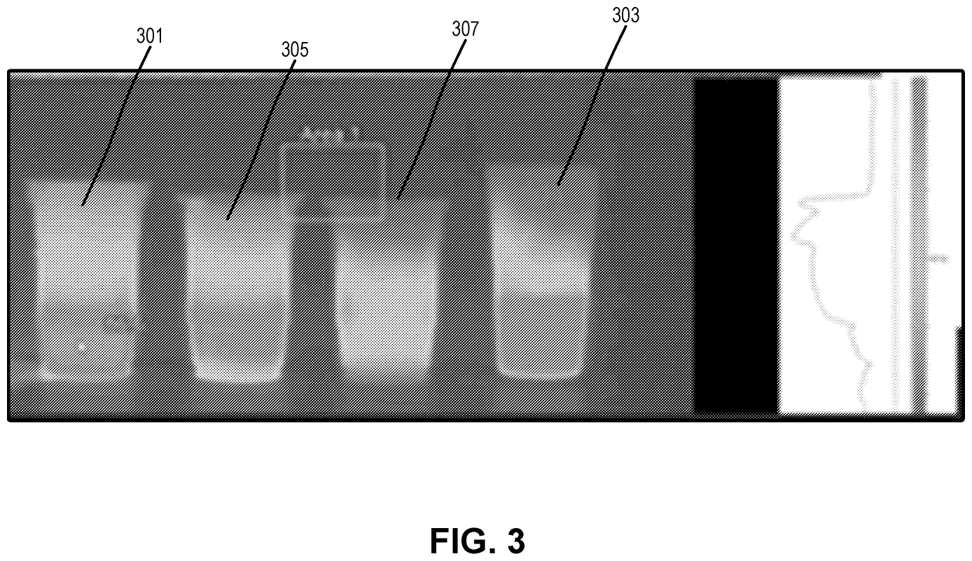

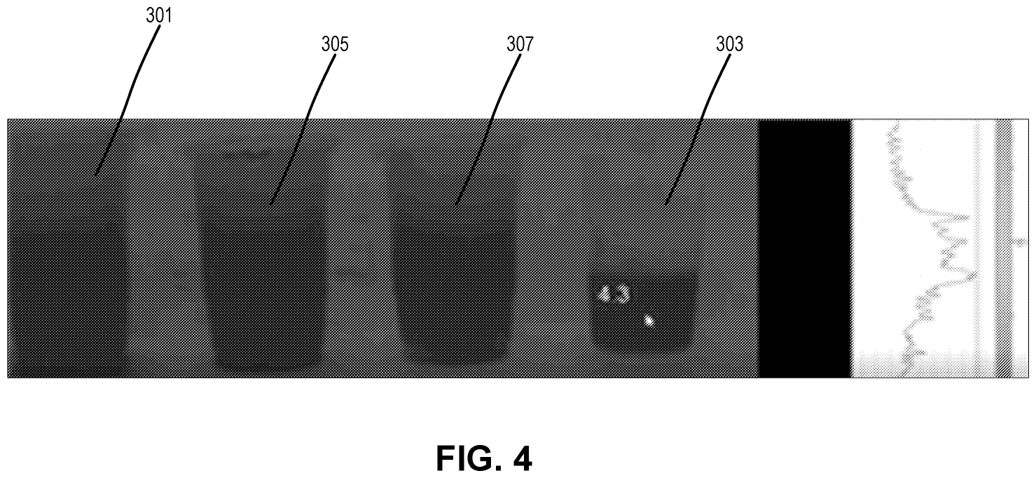

FIGS. 3 and 4 are heat maps illustrating the improved thermal control of primary beverage containers described herein compared to existing primary beverage containers. In FIGS. 3 and 4, a first container 301 was a single-walled container made from an aluminum alloy, a second container 303 was a single-walled container made from cardboard, a third container 305 was a doubled-walled container according to embodiments described herein and including the same aluminum alloy as the first container 301, and a fourth container 307 was the same as the third container 305 and additionally included a cardboard spacer between the inner wall and the outer wall.

In FIG. 3, each container was filled with water having a temperature of 100° C., and the temperatures on the outer walls were measured after 30 seconds. At this time, the first container 301 had a temperature of 86.8° C., the second container 303 had a temperature of 83.3° C., the third container 305 had a temperature of 77.7ºC, and the fourth container 307 had a temperature of 63.3° C. As represented by this test, the primary beverage containers with the double wall (i.e. the third container 305 and the fourth container 307) provided improved thermal insulation compared to the single-walled containers (i.e., they did not become as hot), which may make the containers more comfortable to hold.

In FIG. 4, each container was filled with water having a temperature of 0° C., and the temperatures on the outer walls were measured after 30 seconds. At this time, the first container 301 had a temperature of 4.8° C., the second container 303 had a temperature of 4.3° C., the third container 305 had a temperature of 9.3 ºC, and the fourth container 307 had a temperature of 12.2° C. As represented by this test, the primary beverage containers with the double wall (i.e. the third container 305 and the fourth container 307) provided improved thermal insulation compared to the single-walled containers (i.e., they did not become as cold), which may make the containers more comfortable to hold.

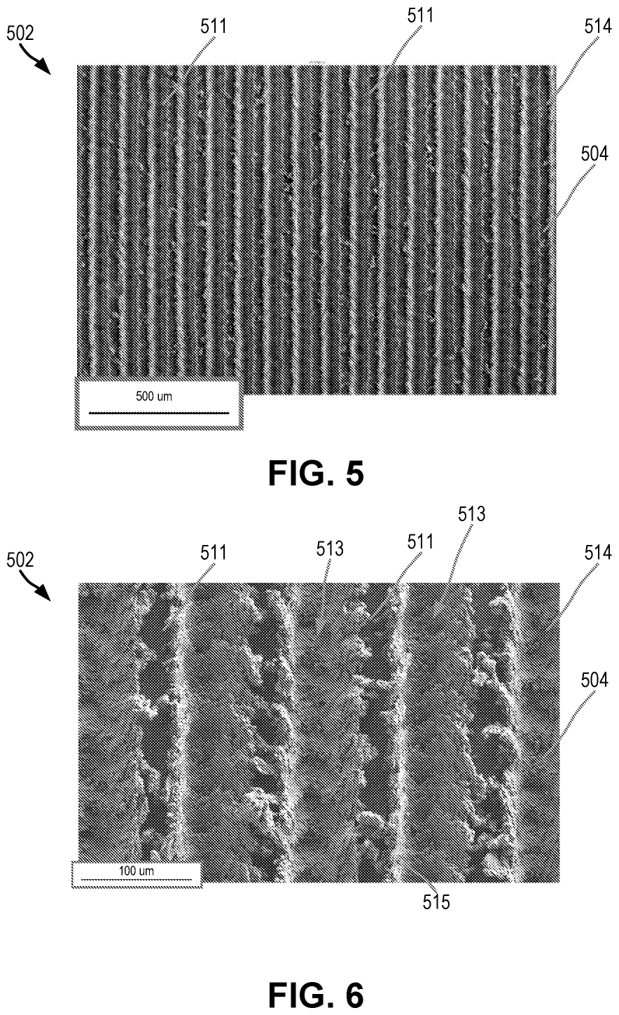

FIGS. 5 and 6 illustrate a portion of an outer wall 504 of container body 502 according to various embodiments. The outer wall 504 of the container body 502 is substantially similar to the outer wall 104 of the container body 102 except that an outer surface 514 of the outer wall 504 has been laser textured, and one or more trenches 511 are defined in the outer surface 514. As best illustrated in FIG. 6, an air gap 513 is defined between adjacent trenches 511. The laser texturing may form an oxide layer 515 on the outer surface 514. In certain embodiments, the oxide layer formed from laser texturing optionally may have a reduced thickness compared to anodizing. In one non-limiting example, the oxide layer 515 may be from greater than 0 nm to about 100 nm, although in other embodiments the oxide layer 515 may be other thicknesses as desired. The trenches 511 formed by the laser texturing may have various depths as desired. In some embodiments, the trenches 511 may have a trench depth of from greater than 0 μm to about 25 μm, although in other embodiments the trenches 511 may have other depths as desired. In certain embodiments, the oxide layer 515, the trenches 511 having a trench depth, and/or the air gaps 513 between adjacent trenches 511 may provide improved thermal insulations for the primary beverage container with the container body 502.

The number, shape, and pattern of the trenches 511 and/or the air gap 513 should not be considered limiting. Moreover, while the laser texturing is illustrated on the outer surface 514 of the outer wall 504, in other embodiments, any of the surfaces of the container body 502 may be laser textured as desired.

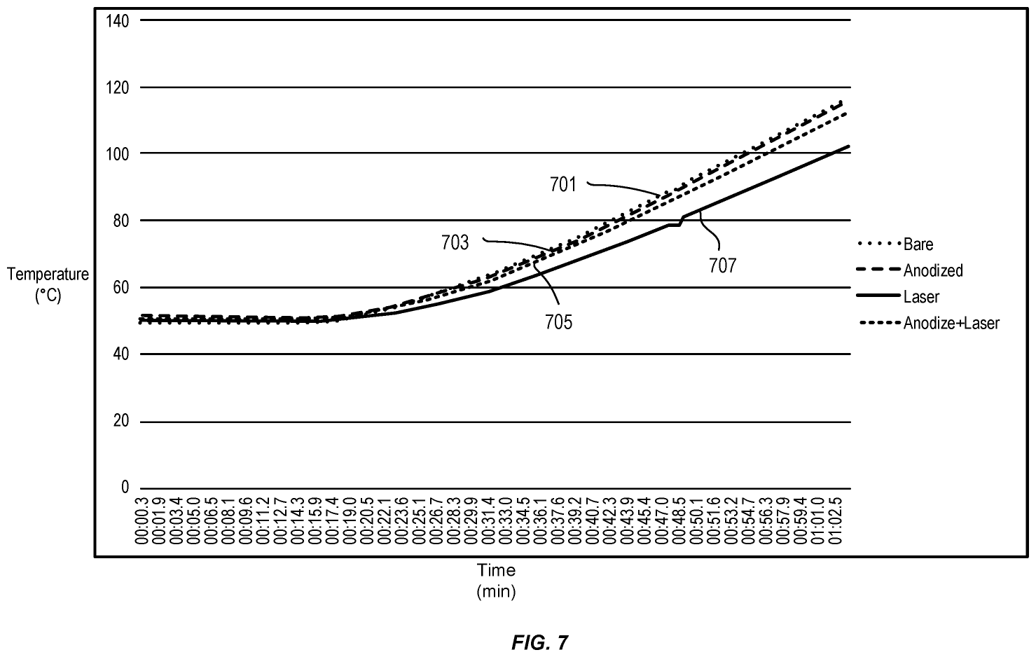

FIG. 7 is a graph illustrating the heating rate of four metal sheets used to form container bodies of primary beverage containers according to embodiments, wherein the y-axis is the temperature in Celsius and the x-axis is the time in minutes. In this embodiment, all metal sheets were constructed from the same type of aluminum alloy. The metal sheet represented by the evenly spaced dotted line 701 had no further treatments/was tested as-received; the metal sheet represented by the dash-dot line 703 was anodized; the metal sheet represented by the dash-dot-dot line 705 was anodized and laser textured; and the metal sheet represented by the solid line 707 was laser textured. Each metal sheet was placed on a hot plate, and the hot plate was heated to >100° C. Each metal sheet was measured to determine the amount of time it took the metal sheet to reach 100° C.

As illustrated in FIG. 7, the metal sheet represented by line 701 took 54.1 seconds to reach 100° C., the metal sheet represented by line 703 took 54.5 seconds to reach 100° C., the metal sheet represented by line 705 took 56.4 seconds to reach 100° C., and the metal sheet represented by line 707 took 1 minute and 2.4 seconds to reach 100° C. After 1 minute and 2.5 seconds, the metal sheet represented by line 701 had a temperature of 115.3 ºC, the metal sheet represented by line 703 had a temperature of 115.2° C., the metal sheet represented by line 705 had a temperature of 111.5° C., and the metal sheet represented by line 707 had a temperature of 100.9° C. As indicated by these results, the metal sheets with the anodizing and/or laser texturing (i.e., lines 703, 705, 707) all took longer to reach 100° C. compared to the bare sheet (line 701), thus suggesting improved thermal insulation. Moreover, the laser textured metal sheet (line 707) took the longest to reach 100° C., indicating that it has the best thermal insulation of all the samples tested.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A primary beverage container comprising: a container body comprising: an outer wall comprising a first outer surface and a first inner surface, wherein the outer wall defines a bottom end of the container body; and an inner wall comprising a second outer surface and a second inner surface, wherein the outer wall and the inner wall each comprise an aluminum alloy, wherein the inner wall and the outer wall are joined at a top end of the container body opposite from the bottom end, wherein the second inner surface defines an inner cavity comprising an opening at the top end of the container body, and wherein the second outer surface is spaced apart from the first inner surface between the top end and bottom end of the container body thereby defining an outer cavity; and a container end joined to the top end of the container body and covering the opening of the inner cavity.

Illustration 2. The primary beverage container of any preceding or subsequent illustrations or combination of illustrations, wherein the aluminum alloy of the outer wall is different from the aluminum alloy of the inner wall.

Illustration 3. The primary beverage container of any preceding or subsequent illustrations or combination of illustrations, wherein the aluminum alloy of the outer wall is the same as the aluminum alloy of the inner wall.

Illustration 4. The primary beverage container of any preceding or subsequent illustrations or combination of illustrations, wherein the container end comprises an opening feature configured to provide access to the inner cavity.

Illustration 5. The primary beverage container of any preceding or subsequent illustrations or combination of illustrations, wherein the opening feature comprises a pull-tab.

Illustration 6. The primary beverage container of any preceding or subsequent illustrations or combination of illustrations, wherein the opening feature is re-closable such that the inner cavity is selectively opened or closed.

Illustration 7. The primary beverage container of any preceding or subsequent illustrations or combination of illustrations, wherein the container end is removably joined to the container end.

Illustration 8. The primary beverage container of any preceding or subsequent illustrations or combination of illustrations, wherein the container end comprises an aluminum alloy.

Illustration 9. The primary beverage container of any preceding or subsequent illustrations or combination of illustrations, wherein the container end seals the inner cavity.

Illustration 10. The primary beverage container of any preceding or subsequent illustrations or combination of illustrations, wherein at least one of outer wall or the inner wall are anodized and/or laser textured.

Illustration 11. The primary beverage container of any preceding or subsequent illustrations or combination of illustrations, further comprising a spacer within the outer cavity, wherein the spacer contacts at least a portion of the first inner surface and at least a portion of the second outer surface.

Illustration 12. The primary beverage container of any preceding or subsequent illustrations or combination of illustrations, wherein the spacer comprises an insulating material comprising a thermal conductivity less than a thermal conductivity of less than at least one of the outer wall or the inner wall.

Illustration 13. The primary beverage container of any preceding or subsequent illustrations or combination of illustrations, wherein a volume of the inner cavity is less than a volume of the outer cavity.

Illustration 14. A method of forming a primary beverage container, the method comprising: forming a container body comprising an outer wall and an inner wall, wherein the outer wall and the inner wall each comprise an aluminum alloy, wherein the outer wall defines a bottom end of the container body, wherein the inner wall defines an inner cavity, and wherein forming the container body comprises: positioning the inner wall between a top end opposite from the bottom end and the bottom end of the container body, such that the inner wall is spaced apart from the outer wall from the top end to the bottom end and defines an outer cavity between the inner wall and the outer wall; and joining the inner wall and the outer wall at the top end of the container body; and joining a container end with the container body such that the container end covers an opening to the inner cavity.

Illustration 15. The method of any preceding or subsequent illustrations or combination of illustrations, wherein forming the container body comprises at least one of seaming, crimping, soldering, welding, blow-forming, or roll-bonding the inner wall and the outer wall.

Illustration 16. The method of any preceding or subsequent illustrations or combination of illustrations, wherein joining the container end with the container body comprises at least one of seaming, crimping, soldering, or welding.

Illustration 17. The method of any preceding or subsequent illustrations or combination of illustrations, wherein forming the container body further comprises retaining a spacer within the outer cavity between the outer wall and the inner wall, wherein the spacer comprises a thermal conductivity less than a thermal conductivity of less than at least one of the outer wall or the inner wall.

Illustration 18. The method of any preceding or subsequent illustrations or combination of illustrations, wherein joining the container end with the container body comprises removably attaching the container end to the top end.

Illustration 19. The method of any preceding or subsequent illustrations or combination of illustrations, wherein joining the container end with the container body comprises sealing the inner cavity.

Illustration 20. The method of any preceding or subsequent illustrations or combination of illustrations, further comprising filling the inner cavity with a liquid before joining the container end with the container body, wherein joining the container end with the container body seals the liquid within the inner cavity of the primary beverage container.

Illustration 21. The method of any preceding or subsequent illustrations or combination of illustrations, further comprising anodizing and/or laser texturing at least one of the inner wall or the outer wall.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Reference to embodiments have element A and/or element B covers embodiments having element A alone, element B alone, or elements A and B taken together. While the systems and methods described herein can be used with any metal, they may be especially useful with aluminum or aluminum alloys.

In this description, reference is made to alloys identified by aluminum industry designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A primary beverage container comprising:
a container body comprising:
an outer wall comprising a first outer surface and a first inner surface, wherein the outer wall defines a bottom end of the container body; and
an inner wall comprising a second outer surface and a second inner surface, wherein the outer wall and the inner wall each comprise an aluminum alloy, wherein the inner wall and the outer wall are joined at a top end of the container body opposite from the bottom end, wherein the second inner surface defines an inner cavity comprising an opening at the top end of the container body, and wherein the second outer surface is spaced apart from the first inner surface between the top end and bottom end of the container body thereby defining an outer cavity; and
a container end joined to the top end of the container body and covering the opening of the inner cavity.

2. The primary beverage container of claim 1, wherein the aluminum alloy of the outer wall is different from the aluminum alloy of the inner wall.

3. The primary beverage container of claim 1, wherein the aluminum alloy of the outer wall is the same as the aluminum alloy of the inner wall.

4. The primary beverage container of claim 1, wherein the container end comprises an opening feature configured to provide access to the inner cavity.

5. The primary beverage container of claim 4, wherein the opening feature comprises a pull-tab.

6. The primary beverage container of claim 4, wherein the opening feature is reclosable such that the inner cavity is selectively opened or closed.

7. The primary beverage container of claim 1, wherein the container end is removably joined to the container end.

8. The primary beverage container of claim 1, wherein the container end comprises an aluminum alloy.

9. The primary beverage container of claim 1, wherein the container end seals the inner cavity.

10. The primary beverage container of claim 1, wherein at least one of outer wall or the inner wall are anodized and/or laser textured.

11. The primary beverage container of claim 1, further comprising a spacer within the outer cavity, wherein the spacer contacts at least a portion of the first inner surface and at least a portion of the second outer surface.

12. The primary beverage container of claim 11, wherein the spacer comprises an insulating material comprising a thermal conductivity less than a thermal conductivity of less than at least one of the outer wall or the inner wall.

13. The primary beverage container of claim 1, wherein a volume of the inner cavity is less than a volume of the outer cavity.

14. A method of forming a primary beverage container, the method comprising:
forming a container body comprising an outer wall and an inner wall, wherein the outer wall and the inner wall each comprise an aluminum alloy, wherein the outer wall defines a bottom end of the container body, wherein the inner wall defines an inner cavity, and wherein forming the container body comprises:
positioning the inner wall between a top end opposite from the bottom end and the bottom end of the container body, such that the inner wall is spaced apart from the outer wall from the top end to the bottom end and defines an outer cavity between the inner wall and the outer wall; and
joining the inner wall and the outer wall at the top end of the container body; and
joining a container end with the container body such that the container end covers an opening to the inner cavity.

15. The method of claim 14, wherein forming the container body comprises at least one of seaming, crimping, soldering, welding, blow forming, or roll bonding the inner wall and the outer wall, and wherein joining the container end with the container body comprises at least one of seaming, crimping, soldering, or welding.

16. The method of claim 14, further comprising anodizing and/or laser texturing at least one of the inner wall or the outer wall.

17. The method of claim 14, wherein forming the container body further comprises retaining a spacer within the outer cavity between the outer wall and the inner wall, wherein the spacer comprises a thermal conductivity less than a thermal conductivity of less than at least one of the outer wall or the inner wall.

18. The method of claim 14, wherein joining the container end with the container body comprises removably attaching the container end to the top end.

19. The method of claim 14, wherein joining the container end with the container body comprises sealing the inner cavity.

20. The method of claim 14, further comprising filling the inner cavity with a liquid before joining the container end with the container body, wherein joining the container end with the container body seals the liquid within the inner cavity of the primary beverage container.
